(19) United States
(12) Patent Application Publication
(10) Pub. No.: US 2022/0120657 A1
(43) Pub. Date: Apr. 21, 2022

(54) SYSTEM AND METHOD FOR QUANTIFYING MECHANICAL PROPERTIES OF A CELL

(71) Applicant: City University of Hong Kong, Hong Kong (CN)

(72) Inventors: Raymond Hiu-wai Lam, Hong Kong (CN); Jifeng Ren, Hong Kong (CN)

(21) Appl. No.: 17/451,327

(22) Filed: Oct. 19, 2021

Related U.S. Application Data
(60) Provisional application No. 63/093,369, filed on Oct. 19, 2020.

(51) Int. Cl. G01N 15/10; B01L 3/00; G06T 7/00; G06T 7/62

(52) U.S. Cl. CPC G01N 15/1056; B01L 3/502761; G06T 7/0012; G06T 7/62; B01L 2200/0663; G06T 2207/30024; B01L 2300/0663; B01L 2300/14; B01L 2400/0487; G01N 2015/1006; G01N 2015/1093; B01L 2200/10

(57) ABSTRACT

The present disclosure relates to systems and methods for quantifying mechanical properties of a cell containing a nucleus and cytoplasm. The system comprises a microfluidic comprises a varying width configured to deform the cell to multiple deformation levels, an imaging device configured to obtain image data of the cell received by the microfluidic channel and a processor in communication with the imaging device. The processor is configured to receive, from the imaging device, image data of the cell deformed within the microfluidic channel at a first deformation level and a second deformation level different from the first deformation level and to determine, based on the image data, one or more parameters associated with the deformed cell at the first deformation level and the second deformation level.

### FIELD OF INVENTION

The present invention relates broadly, but not exclusively, to a system and a method for quantifying mechanical properties of a cell.

### BACKGROUND

Cell nucleus regulates activities of cells and stores genetic materials that contain hereditary information. Mechanical properties of a cell nucleus, such as the elasticity and viscosity, are known to be important factors that affect cancer cells development and migration. Existing studies on cells have revealed that cancerous cells are usually more deformable comparing to benign cells, thereby promoting migration of cancerous cells to other parts of the body to establish new colonies. Hence, cell stiffness has been considered an effective biomarker for certain cancers such as lung carcinoma and ovarian cancer.

Accordingly, it is important to accurately quantify the mechanical properties of a cell nucleus to advance the understanding of the role of cell mechanics in the development of diseases. There are various existing methods that are used to quantify mechanical properties of a cell nucleus which involve either assessing an extracted nucleus or an unextracted nucleus (i.e. a nucleus contained in a cell). However, mechanical properties of a cell nucleus are difficult to be quantified accurately by existing methods due to some limitations associated with these methods.

For example, some existing methods may involve process such as mechanical or chemical nuclear extraction that changes the mechanical properties of the nucleus, thereby compromising the reliability of the results obtained from the methods. Also, the results obtained from some of the existing methods may be highly dependent on variables such as the probing positions of the nucleus. Consequently, the mechanical properties quantification using these methods may not be accurate.

Additionally, some existing methods may require the use of certain techniques, such as atomic force microscopy indentations or micropipette aspirations, which involve the use of relatively expensive instruments or can only be performed by skilled operators.

A need therefore exists to provide a system and method that seek to address at least one of the problems above or to provide a useful alternative.

### SUMMARY

According to a first aspect of the present invention, there is provided a system for quantifying mechanical properties of a cell containing a nucleus and cytoplasm, the system comprising:

a microfluidic channel comprising an inlet configured to receive the cell and an outlet in fluid communication with the inlet, wherein the microfluidic channel comprises a varying width configured to deform the cell to multiple deformation levels;

an imaging device configured to obtain image data of the cell received by the microfluidic channel; and

a processor in communication with the imaging device, wherein the processor is configured to:
receive, from the imaging device, image data of the cell deformed within the microfluidic channel at a first deformation level and a second deformation level different from the first deformation level;
determine, based on the image data, one or more parameters associated with the deformed cell at the first deformation level and the second deformation level;
calculate, using the one or more parameters, a first elastic modulus of the cell at the first deformation level and a second elastic modulus of the cell at the second deformation level; and
calculate, using the first and second elastic moduli, a nuclear modulus of the nucleus and a cytoplasmic modulus of the cytoplasm.

According to a second aspect of the present invention, there is provided a method for quantifying mechanical properties of a cell containing a nucleus and cytoplasm, the method comprising:

obtaining image data of the cell deformed within a microfluidic channel at a first deformation level and a second deformation level different from the first deformation level, the microfluidic channel comprising an inlet configured to receive the cell and an outlet in fluid communication with the inlet, wherein the microfluidic channel comprises a varying width configured to deform the cell to multiple deformation levels;

determining, based on the image data, one or more parameters associated with the deformed cell at the first deformation level and the second deformation level;

calculating, using the one or more parameters, a first elastic modulus of the cell at the first deformation level and a second elastic modulus of the cell at the second deformation level; and

calculating, using the first and second elastic moduli, a nuclear modulus of the nucleus and a cytoplasmic modulus of the cytoplasm.

The parameters may be selected from a group consisting of: a penetration length of the cell from the inlet of the microfluidic channel, a length of the cell measured along a length of the microfluidic channel, a width of the cell measured along a width of the microfluidic channel and a diameter of the cell in an undeformed state.

The first deformation level may comprise a deformation of the cytoplasm and the nucleus is undeformed, and the second deformation level may comprise a deformation of both the cytoplasm and the nucleus.

The microfluidic channel may comprise a width that tapers from the inlet towards the outlet.

The processor may be configured to calculate the first and second elastic moduli using the parameters in a hyperelastic Tatara model.

The system may further comprise a fluid pump configured to:

apply a first pressure through the inlet to move the cell along the microfluidic channel until the cell is deformed to the first deformation level; and

apply a second pressure through the inlet to move the cell along the microfluidic channel until the cell is deformed to the second deformation level, wherein the second pressure is higher than the first pressure.

The processor may be configured to classify the cell using a quadratic discriminant analysis based on the nuclear modulus of the nucleus.

The inlet may comprise a width of 10 μm-50 μm and the outlet may comprise a width of 1 μm-10 μm.

The cell may comprise one selected from a group consisting of an adherent cell, a suspension cell, a non-adherent cell and a dissociated adherent cell.

### BRIEF DESCRIPTION OF THE DRAWINGS

Embodiments of the invention are provided by way of example only, and will be better understood and readily apparent to one of ordinary skill in the art from the following written description and the drawings, in which:

FIG. 1A illustrates a diagram of a microfluidic device used for quantifying mechanical properties of a cell in accordance with an example embodiment.

FIG. 1B illustrates a diagram of a microscopic image of a deformed whole cell captured in a microfluidic channel in the microfluidic device of FIG. 1A.

FIG. 2A illustrates laminar flow simulation results of a single microfluidic channel containing a captured cell in accordance with an example embodiment.

FIG. 2B illustrates a graph showing the effective drag force on cells of various sizes captured in a microfluidic channel based on the simulation results of FIG. 2A.

FIG. 3A illustrates diagrams of a captured whole cell in a microfluidic channel under a small deformation in accordance with an example embodiment.

FIG. 3B illustrates diagrams of a captured whole cell in a microfluidic channel under a large deformation in accordance with the same embodiment shown in FIG. 3A.

FIG. 4A illustrates bright-field and fluorescence micrographs of NP460 whole cells and NPC43 whole cells (left), and the bright-field and fluorescence micrographs of chemically extracted nuclei of NP460 cells and NPC43 cells (right).

FIG. 4B illustrates a bar graph showing diameters of nuclei within NPC43 and NP460 whole cells (unextracted nuclei) and the extracted nuclei of NPC43 and NP460 cells.

FIG. 5A illustrates microscopic images of a nasopharyngeal epithelial cell NP460 captured in a microfluidic channel under driving pressures of 100 Pa and 400 Pa.

FIG. 5B illustrates microscopic images of a nasopharyngeal cancerous cell NPC43 captured in a microfluidic channel under driving pressures of 100 Pa and 400 Pa.

FIG. 5C illustrates a bar graph showing the whole cell elasticity of NP460 cell and NPC43 cell.

FIG. 5D illustrates microscopic images of a deformed extracted nuclei of NP460 and NPC43 cells captured in a microfluidic channel (top) and key parameters in the deformed extracted nuclei (bottom).

FIG. 5E illustrates a bar graph showing the values of nuclear moduli E_{nuclear} obtained based on parameters of the chemically extracted nuclei and the values of nuclear moduli E_{nuclear} obtained based on parameters of the whole cells (unextracted nuclei).

FIG. 6A illustrates cell viability test results of cells recollected from the quantification procedure and cells used as a control group.

FIG. 6B illustrates a bar graph showing the live cell percentage in the recollected cells and the control group of FIG. 6A.

FIG. 7A illustrates immunofluorescence images of Lamin A/C expressions for nuclei in NPC43 and NP460 cells (unextracted nuclei) and the chemically extracted nuclei of NPC43 and NP460 cells.

FIG. 7B illustrates a bar graph showing the total fluorescence intensity of the unextracted and extracted nuclei.

FIG. 8A illustrates scatter plot graphs for cell classification displaying values of whole cell elastic moduli against cell diameter under pressure of 100 Pa (left) and 400 Pa (right).

FIG. 8B illustrates scatter plot graphs for cell classifications displaying values of cytoplasmic elasticity against cell diameter (left) and nuclear elasticity versus nuclear diameter (right).

FIG. 9 illustrates a schematic diagram illustrating a computer suitable for implementing the system and method of the example embodiments

FIG. 10A illustrates a 3D view of a Hoechst 33342 stained NPC43 cell and the cross-sectional views across x-, y- and z-planes.

FIG. 10B illustrates a 3D view of a Hoechst 33342 stained NPC460 cell and the cross-sectional views across x-, y- and z-planes.

FIG. 11A illustrates diagram of the flow sections in the whole microfluidic device.

FIG. 11B illustrates a circuit model of flow resistances distributions for flow sections.

FIG. 12A illustrates bar graphs showing nuclear diameter distributions of NP460 and NPC43 cells.

FIG. 12B illustrates bar graphs showing nuclear elasticity distributions of NP460 and NPC43 cells.

### DETAILED DESCRIPTION

Embodiments of the present invention disclose a simple and non-destructive single-cell nuclear elasticity quantification system and method to quantify mechanical properties of a cell containing a nucleus and cytoplasm. The mechanical properties include the elastic modulus of the whole cell (denoted as E), the elastic modulus of the nucleus (i.e. nuclear modulus, E_{nuclear}) and the elastic modulus of the cytoplasm (i.e. cytoplasmic modulus, E_{cyto}). Notably, the system and method can be applied directly to unattached cells as well as a suspension cell, a non-adherent cell and a dissociated adherent cell. Additionally, the proposed system and method are also capable of cell mechanical properties quantification in blood samples. The system and method can also be applied directly to an extracted nucleus to calculate the elastic modulus of the extracted nucleus, considering that an extracted nucleus generally behaves as a homogeneous soft sphere.

The system and method involve examining an individual live whole cell captured along a microfluidic channel to obtain parameters of the cell when it is deformed under two different deformation levels. The cell deformation is achieved by driving a live whole cell along the microfluidic channel at a constant pressure such that the cell is clamped by the narrowing sidewalls of the microfluidic channel. Different deformation levels can be achieved by varying the pressure applied to the cell through an inlet of the microfluidic channel.

The elastic moduli of the whole cell at the two different deformation levels are calculated based on the parameters of the whole cell under the two different deformation levels. It is found that the elastic modulus of the whole cell under a relatively large cell deformation is significantly larger than the elastic modulus of the whole cell under a relatively small cell deformation. This implies that the increase in the elastic modulus or ‘modulus jump’ is attributed to the nuclear modulus. In other words, the elastic modulus of the whole cell under a relatively large cell deformation is contributed by the cytoplasmic and nuclear elasticities, while the elastic modulus of the whole cell under a relatively small cell deformation is contributed by the cytoplasmic elasticity only. Equations are developed based on a representative hyperelastic Tatara model describing cell mechanics to decouple contributions of the cytoplasmic and nuclear elasticities to the elastic modulus of the cell in respect of the relatively large cell deformation, thereby quantifying the nuclear modulus and cytoplasmic modulus.

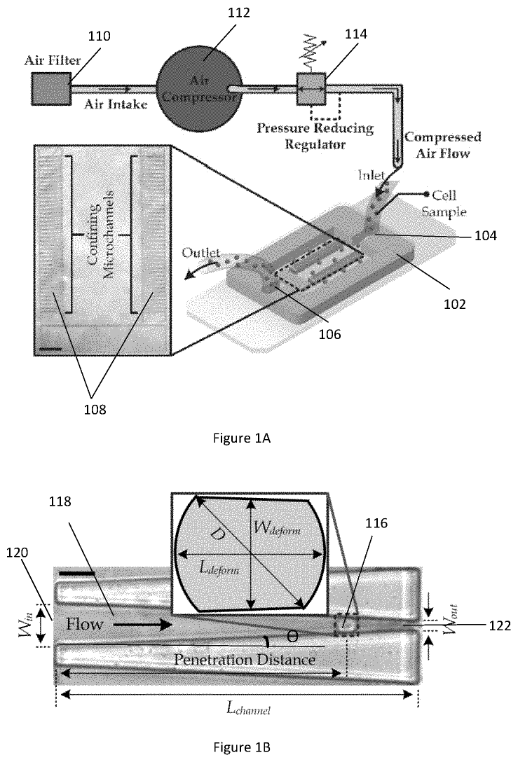

FIG. 1A illustrates a diagram of a microfluidic device 102 used for quantifying mechanical properties of a cell in accordance with an example embodiment. The microfluidic device 102 has an inlet 104 to receive a sample and an outlet 106 to dispense the sample. The microfluidic device 102 further includes two arrays 108 of confining microfluidic channels with forty microfluidic channels in each array. The microfluidic channels can be used to capture the cell for quantifying mechanical properties of the cell.

A sample of the cell is driven from an air filter 110 to a fluid pump (shown as an air compressor 112 in FIG. 1A), which applies pressure to drive the sample into the inlet 104 of the microfluidic device 102. The pressure applied to the sample can be regulated by a pressure reducing regulator 114. It should be noted that the flow resistance in a microfluidic channel will increase significantly after a cell enters the microfluidic channel, thereby restricting other cells to enter the same microfluidic channel. As a result, other cells in the sample will move to other unoccupied microfluidic channels. Accordingly, nearly eighty individual cells can be examined in the microfluidic device 102 in each experiment.

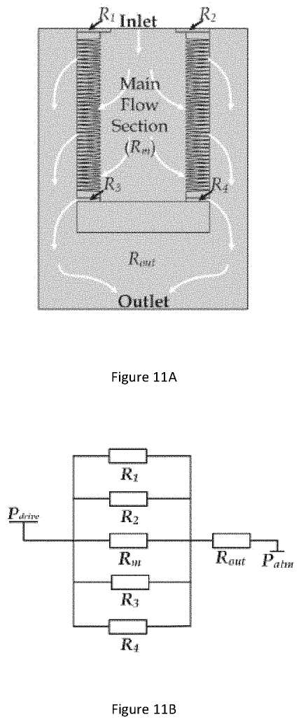

Also, it is noted that the pressure distributed on the microfluidic channels account for over 99% pressure difference between the inlet 104 and outlet 106 of the microfluidic device 102 (see description below with respect to FIGS. 11A and 11B for further details). Thus, the driving pressures applied on the microfluidic device 102 can be used in calculations as the pressure differences between inlets and outlets of the microfluidic channels.

FIG. 1B illustrates a diagram of a microscopic image of a deformed whole cell 116 captured in a microfluidic channel 118 in the microfluidic device 102 of FIG. 1A. A microscopy device is configured to obtain image data of the whole cell 116 captured in the microfluidic channel 118. Each microfluidic channel 118 has a linear confined shape, an inlet 120 configured to receive the cell and an outlet 122 in fluid communication with the inlet 120. The microfluidic channel 116 has a varying width configured to deform the cell to multiple deformation levels. In the embodiment shown in FIG. 1B, the microfluidic channel 118 tapers from the inlet 120 towards the outlet 122 such that the width decreases at a consistent rate from its inlet Wᵢₙ to its outlet Wₒᵤₜ. Wᵢₙ should be large enough to cover the size range of the whole cell 116, whereas Wₒᵤₜ should be small enough to capture the extracted cell nuclei of the whole cell 116. In an embodiment, the inlet 120 has a width of 10 μm-50 μm and the outlet 122 has a width of 1 μm-10 μm. A cell or nucleus deforms at a continually increasing rate along the microfluidic channel 118 due to the reducing width of the microfluidic channel 118.

The microfluidic channel 118 has a taper angle θ that reflects the rate of change of the width of the microfluidic channel 118 along the microfluidic channel length L_{channel} direction. The taper angle θ should be a relatively small angle and can be calculated using the equation:

θ=tan⁻¹((Wᵢₙ−Wₒᵤₜ)/(2L_{channel})) (1)

The position of the whole cell 116 is determined with reference to its distance from the inlet 120 of the microfluidic channel 118 which can be directly observed under the microscopy device and is called ‘penetration length L’. A processor receives image data of the whole cell 116 from the microscopy device and, based on the image data obtained by the microscopy device, the processor determines the parameters associated with the deformed whole cell 116 at a first position and a second position along the microfluidic channel 118.

The penetration length L determines the deformed cell length W_{deform} along the microfluidic channel width direction. The deformed cell length W_{deform} can be calculated using the equation:

W_{deform}=(Wₒᵤₜ−Wᵢₙ)L_{channel}/L+Wᵢₙ (2)

The penetration length L also affects the cell length L_{deform} along the channel length direction which can be directly measured in the image captured by the microfluidic device 102. Based on the assumption that the deformed cell would have no change in its volume, the diameter D of the cell at its undeformed state can be calculated using the equation:

$$D = \sqrt[3]{\frac{3 {L}_{deform}^{2} {W}_{deform} - {W}_{deform}^{3}}{2}} \qquad ( 3 )$$

It will be appreciated by a person skilled in the art that the microfluidic channel 118 may include different shape, size and dimension. Any microfluidic channel that can releasably capture and deform cells in a non-destructive manner can be used in the quantification of the mechanical properties system and method as disclosed herein.

The microfluidic device is constructed such that at least the area in which the cell is captured within the microfluidic channels can be viewed and imaged by an imaging device. The imaging device may include, but not limited to, a microscope, an imager and a camera. The sample may be a compressed air or gas source.

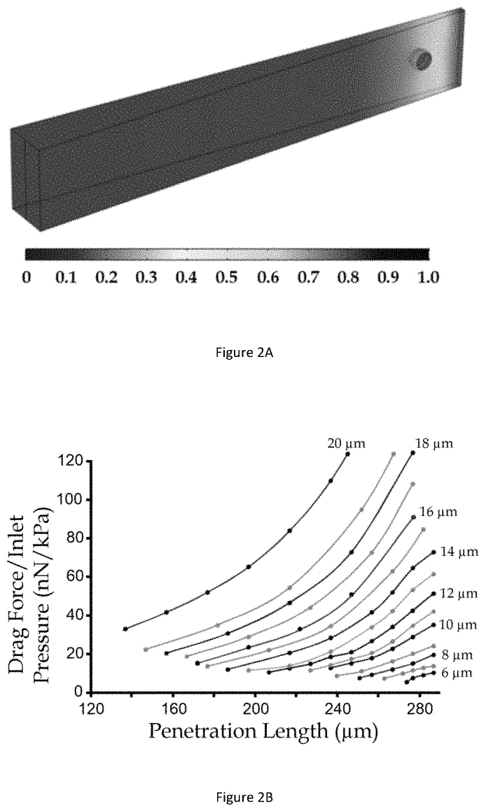

FIG. 2A illustrates laminar flow simulation results of a single microfluidic channel containing a captured cell in accordance with an example embodiment. The flow along the confining microfluidic channel is laminar with a very small Reynolds number (<<1), given the micro-scale of the dimensions of the microfluidic channel. The simulation is calculated using COMSOL Multiphysics 5.2a and a representative normalized pressure distribution of the microfluidic channel is shown in FIG. 2A.

FIG. 2B illustrates a graph showing the effective drag force on cells of various sizes captured in a microfluidic channel based on the simulation results of FIG. 2A. The pressure distribution around a cell with a size ranging from 6 μm to 20 μm against the penetration length along the microfluidic channel is analyzed. The surface stress around the cell is integrated to obtain the effective drag force on the captured cell and the computed drag forces is plotted in the line graph in FIG. 2B.

As shown in FIG. 2B, the drag force scales linearly with the driving pressure because of the laminar flow characteristics. Therefore, under a steady driving pressure, the values of the penetration length L and cell diameter D can be used to calculate the drag force over the captured cell based on the numerical interpolation of values plotted on the line graph of FIG. 2B.

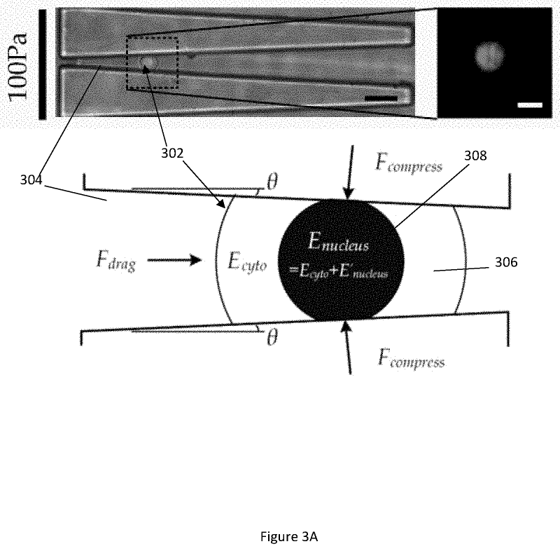

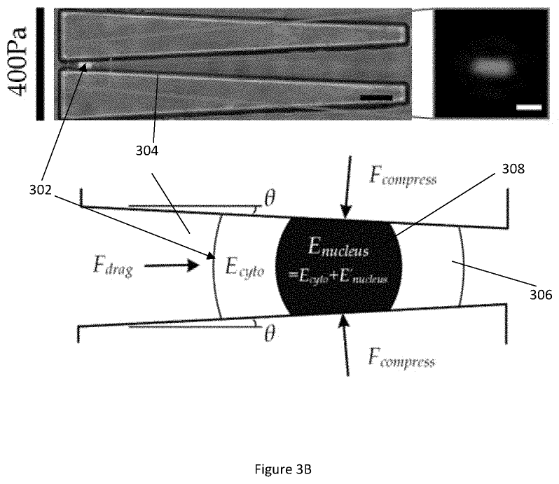

FIG. 3A illustrates diagrams of a captured whole cell 302 in a microfluidic channel 304 under a small deformation in accordance with an example embodiment. FIG. 3B illustrates diagrams of a captured whole cell 302 in a microfluidic channel 304 under a large deformation in accordance with the same embodiment shown in FIG. 3A. A whole cell 302 includes two major cell components: cytoplasm 306 and nucleus 308. Considering that elasticity of the nucleus 308 is often higher than that of the cytoplasm 306 in the whole cell 302, modulus difference (denoted as E′_{nucleus}) between the nuclear modulus E_{nucleus} and the cytoplasmic modulus E_{cyto} is therefore E_{nucleus}=E_{cyto}−E′_{nucleus}. Contributions of the nuclear modulus E_{nucleus} and the cytoplasmic modulus E_{cyto} to the elastic modulus of the whole cell E under the small and large deformations are presented in FIG. 3A (small deformation) and FIG. 3B (large deformation).

The processor calculates the elastic modulus of the whole cell E under the small and large deformations by considering a force balanced state of the captured whole cell 302 and the hyperelastic Tatara model using the following equation:

$$E = [ \frac{3}{4} ( \frac{2}{{D}_{c}} + \frac{Θ {D}_{c}}{{L}_{deform}^{2}} ) - \frac{8 {D}^{2} + {D}_{c}^{2}}{{π ( 8 {D}^{2} + 2 {D}_{c}^{2} )}^{3 / 2}} ( 1 + \frac{Θ {D}_{c}^{2}}{5 {L}_{deform}^{2}} ) ] \frac{3 Φ {F}_{drag}}{4 ( D - {W}_{deform} ) sin θ} \qquad ( 4 )$$

where
F_{drag} is the drag force on the cell
D_{c} is the diameter of the contact area between the cell body and each side of the microfluidic channel walls. D_{c} is calculated with the following equation:

D_{c}=((D²−W_{deform}²)^{1/2}−D−L_{deform}) (5)
Φ and Θ are the correction factors as functions of the deformation level ξ=(1−W_{deform}/D) for the hyperelastic properties. Φ and Θ are calculated with the following equations:

$$\begin{matrix}Φ = \frac{{( 1 - ξ )}^{2}}{1 - ξ + {ξ}^{2} / 3} & ( 6 ) \\ Θ = \frac{1 - ξ / 3}{1 - ξ + {ξ}^{2} / 3} & ( 7 )\end{matrix}$$

There is a significant increment in the whole cell elasticity (i.e. a ‘modulus jump’) measured under a higher driving pressure (400 Pa) that causes the large cell deformation, as compared to the whole cell elasticity measured under the lower driving press (100 Pa) that causes the small cell deformation. To resolve the values of the nuclear modulus E_{nucleus} and the cytoplasmic modulus E_{cyto}, a simplified physical cell structure consisting of only the cytoplasm 306 and the nucleus 308 is adopted to represent the key biomechanical properties of the captured whole cell 302.

The whole cell elasticity measured under the large cell deformation can then be considered as the nucleus and the cytoplasmic body being compressed simultaneously inside the microfluidic channel 304. In other words, the ‘modulus jump’ is attributed to the nuclear deformation.

According to the force balance as shown in FIGS. 3A and 3B, the compressive force is related to the drag force by the following equation:

F_{drag}=2F_{compress}/sin θ (8)

F_{compress} can be calculated by multiplying the driving pressure P with the normalized compressive force (denoted as F*) at 1 kPa as described previously in FIG. 2B. As the penetration length L can be converted to W_{deform}, F* is a function of D and W_{deform}. Hence, Equation (4) can be rewritten as:

F_{compress}=P×F*(D,W_{deform})=K(D,W_{deform})×E(D,W_{deform}) (9)

where K is a function of D and W_{deform}.

The compressive force driven by the inlet pressure is distributed into two smaller compressive forces applied on the cytoplasm 306 and nucleus 308. Therefore, considering compressive forces F₁ and F₂ are caused by the driving pressures of P₁=100 Pa and P₂=400 Pa, respectively, the compressive forces F₁ and F₂ can be calculated with the following equations:

F₁=P₁×F*(D_{cell},W₁)≈K(D_{cell},W₁)E_{cyto}+K(D_{nucleus},W₁)E′_{nucleus} (10)

F₂=P₂×F*(D_{cell},W₂)≈K(D_{cell},W₂)E_{cyto}+K(D_{nucleus},W₂)E′_{nucleus} (11)

where
W₁ and W₂ are the deformed particle width at the driving pressure of P₁ and P₂, respectively.
D_{cell} is the diameter of the cell and D_{nucleus} is the diameter of the nucleus. D_{cell} and D_{nucleus} at the deformed state of the cell and nucleus respectively can be measured from the image captured by the microscopy device, D_{cell} and D_{nucleus} at the undeformed state of the cell and nucleus respectively can be calculated using the Equation (3) above.

Considering the relation as described in Equation (9), the two ‘cytoplasmic’ K value in Equation (10) can be obtained using the following equations:

K=F₁/E(P₁,D_{cell},W₁) (12)

K=F₁/E(P₁,D_{nucleus},W₁) (13)

The two K values in Equation (11) can also be obtained in the same manner using Equations (12) and (13) above. Accordingly, the processor can calculate the cytoplasmic modulus E_{cyto} and the nuclear modulus E_{nucleus} using the following equation:

$$[ \begin{matrix}{E}_{cyto} \\ {E}_{nucleus} - {E}_{cyto}\end{matrix} ] \approx {[ \begin{matrix}K ( {D}_{cell} , {W}_{1} ) & K ( {D}_{nucleus} , {W}_{1} ) \\ K ( {D}_{cell} , {W}_{2} ) & K ( {D}_{nucleus} , {W}_{2} )\end{matrix} ]}^{- 1} [ \begin{matrix}{P}_{1} {F}^{*} ( {D}_{cell} , {W}_{1} ) \\ {P}_{2} {F}^{*} ( {D}_{cell} , {W}_{2} )\end{matrix} ] \qquad ( 14 )$$

### Example

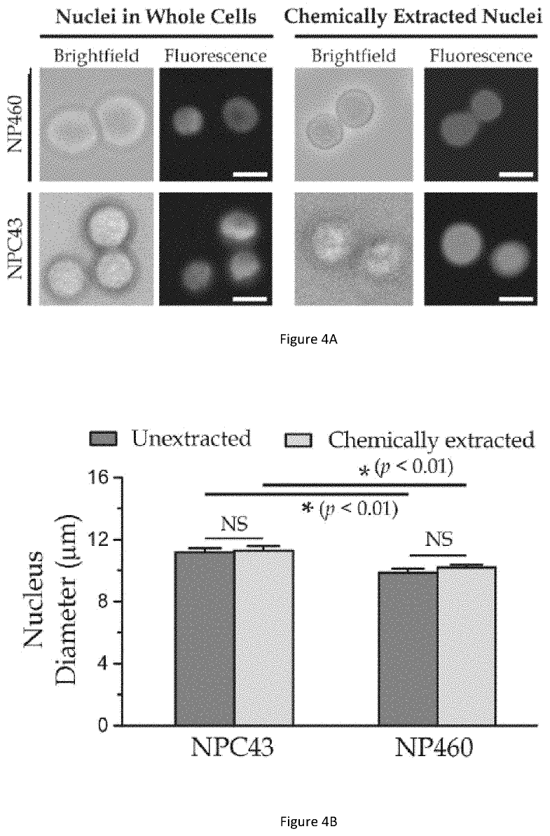

An experiment conducted to quantify mechanical properties of a cell in accordance with an example embodiment is described below with respect to FIGS. 4 to 8.

### Dimensions of Microfluidic Channel

FIG. 4A illustrates bright-field and fluorescence micrographs of NP460 whole cells and NPC43 whole cells (left) in suspension, and the bright-field and fluorescence micrographs of chemically extracted nuclei of NP460 cells and NPC43 cells (right). Considering that dimensions of a microfluidic channel are largely dependent on sizes of the target particles, the diameters of whole cells and nuclei are measured for both the NP460 and NPC43 cells. For measurement of whole cells, the cells are resuspended by typsinization and their diameters are quantified under a bright-field microscope. The diameters measured are 13.84±SD 1.99 μm (N=90) for NP460 cells and 14.18±SD 2.54 μm (N=103) for NPC43 cells.

On the other hand, the fluorescence staining of Hoechst 33342 is applied to visualize the nuclei in whole cells and the chemically extracted nuclei (See description about “nuclear extraction” below in the “supplementary information” section for further details). Notably, it can be observed that the resuspended cells and nuclei are typically in a spherical shape. The diameters of these nuclei are measured for both cell types, results of which are explained in further detail below with respect to FIG. 4B.

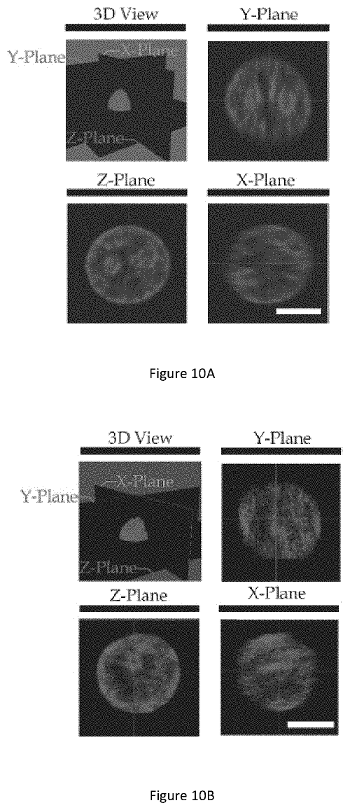

FIG. 4B illustrates a bar graph showing diameters of nuclei within NPC43 and NP460 whole cells (unextracted nuclei) and the extracted nuclei of NPC43 and NP460 cells. 3D shapes of Hoechst 33342-stained nuclei of extracted and unextracted NPC43 and NP460 cells are observed using laser confocal microscopy to further verify the nuclear shapes in 3D view (see description below with respect to FIGS. 10A, 10B for further details). Generally, NPC43 cells have a larger nuclear diameter (unextracted: 11.18±SD 1.62 μm, N=40; chemically extracted: 11.27±SD 1.75 μm, N=40) comparing to those of NP460 cells (unextracted: 9.86±SD 1.55 μm, N=40; chemically extracted: 10.18±SD 1.29 μm, N=40) as summarised in the bar graph of FIG. 4B. Based on these measured whole cell and nuclear sizes, it is configured that the suitable dimensions of the microfluidic channels are Wᵢₙ=30 μm, Wₒᵤₜ=4 μm, L_{channel}=300 μm and θ≈2.5°. Additionally, the suitable channel height is 50 μm to avoid unwanted physical contacts of the captured cells/nuclei with the roof and floor of the microfluidic channel.

### Quantification of Nuclear Elasticity

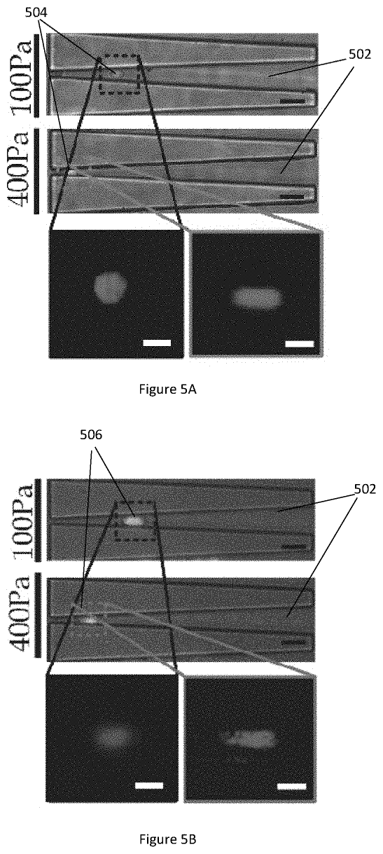

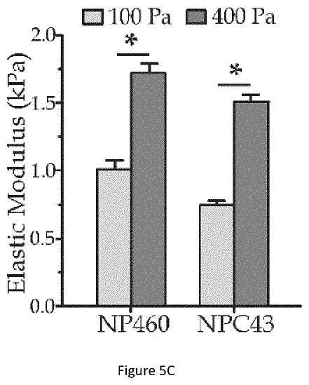

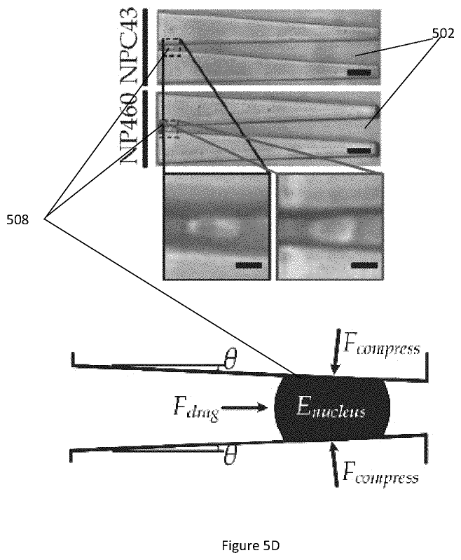

FIG. 5A illustrates microscopic images of a nasopharyngeal epithelial cell NP460 captured in a microfluidic channel 502 under driving pressures of 100 Pa and 400 Pa. FIG. 5B illustrates microscopic images of a nasopharyngeal cancerous cell NPC43 captured in a microfluidic channel 502 under driving pressures of 100 Pa and 400 Pa.

A non-destructive quantification of the nuclear moduli of NP460 cell 504 and NPC43 cell 506 is implemented using the microfluidic channel 502. The cell nuclei are visualized by pre-staining them with fluorescence Hoechst 33342 and the cell density is diluted to a sufficiently low level (about 104 nuclei/mL) for avoiding cell aggregation along the microfluidic channel 502. The cells 504, 506, are injected into the microfluidic device with a driving pressure of 100 Pa, and microscopic images of the captured cells 504, 506 in the microfluidic channel 502 are taken to obtain parameters F₁, W₁, D_{cell} and D_{nucleus}. Next, the driving pressure is increased to 400 Pa and microscopic images of the captured cells 504, 506 are taken again to obtain parameters F₂ and W₂. Afterward, the driving pressure is increased to 1 kPa to recollect all the captured cells 504, 506 at the outlet of the microfluidic device for any further analysis.

FIG. 5C illustrates a bar graph showing the whole cell elasticity of NP460 cell 504 and NPC43 cell 506. The parameters obtained from the microscopic images are used to calculate the elastic modulus of the whole cells NP460 and NPC43 using Equations (3)-(7) above. As shown in the bar graph, the elastic modulus of the cells under driving pressure of 400 Pa are significantly higher than the elastic modulus of the cells under driving pressure of 100 Pa, confirming the modulus jumps for both NP460 and NPC43 cells.

FIG. 5D illustrates microscopic images of a deformed extracted nuclei of NP460 and NPC43 cells captured in a microfluidic channel 502 (top) and key parameters in the deformed extracted nuclei 508 (bottom). It is known that factors such as nucleus extraction procedures, the cell viability and the surrounding conditions may alter nuclear properties. For comparison purposes, an experiment is conducted to quantify elastic modulus of chemically extracted nuclei of NP460 and NPC43 cells using the microfluidic channel 502. The experimental procedures are similar to the method for quantifying mechanical properties of whole cells, except that only one driving pressure level is applied. As the extracted nuclei are smaller than the whole cells in size, the applied pressure level is set at 300 Pa to deform the extracted nuclei. The nuclear moduli are then calculated directly using Equation (4) above. The elastic modulus values of the extracted nuclei are 4.25±SE 0.31 kPa (N=30) for NP460 cell and 3.34±SE 0.15 kPa (N=40) for NPC43 cell.

FIG. 5E illustrates a bar graph showing the values of nuclear moduli E_{nuclear} obtained based on parameters of the chemically extracted nuclei and the values of nuclear moduli E_{nuclear} obtained based on parameters of the whole cells (unextracted nuclei). E_{cyto} and N_{nucleus} are obtained using Equations (10)-(14). As shown in the bar graph, E_{cyto}=0.72±SE 0.03 kPa and E_{nucleus}=4.99±SE 0.62 kPa for NPC43 cells (N=48), and E_{cyto}=0.89±SE 0.05 kPa, E_{nucleus}=6.87±SE 0.68 kPa for NP460 cells (N=47).

By comparing the corresponding results for extracted and unextracted nuclei, it is noted that the extracted nuclei generally have smaller elastic moduli than unextracted nuclei. Such difference implicates that the nuclear properties may be altered by the chemical nucleus extraction procedures.

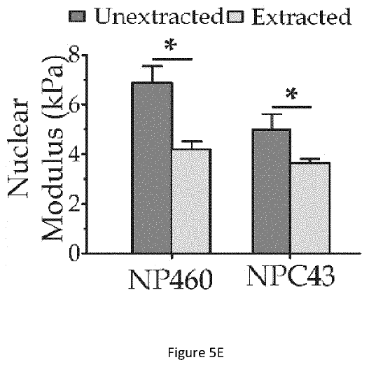

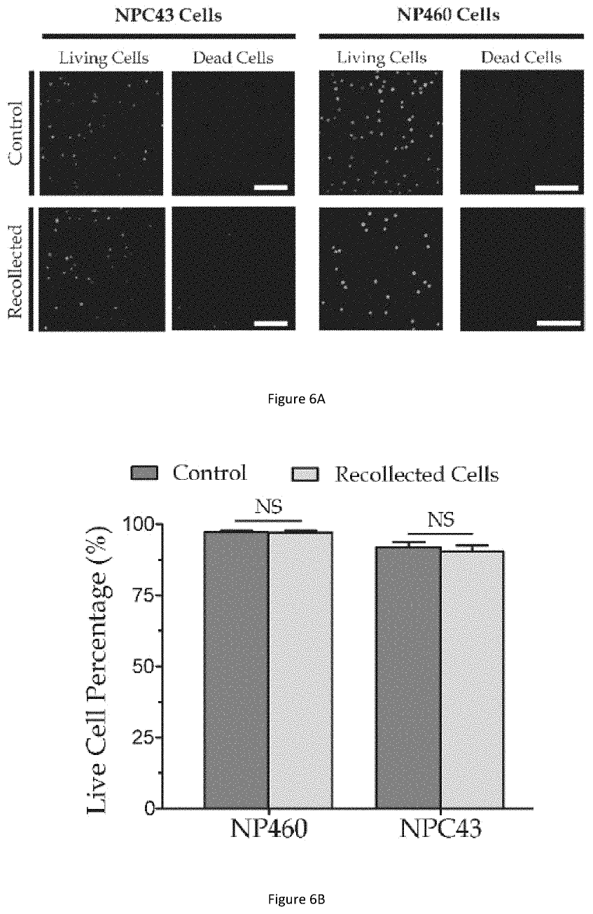

FIG. 6A illustrates cell viability test results of cells recollected from the quantification procedure (labelled as ‘Recollected’) and cells used as a control group (labelled as ‘Control’). FIG. 6B illustrates a bar graph showing the live cell percentage in the recollected cells and the control group of FIG. 6A.

To examine cell viability after the nuclear elasticity quantification procedure, cell live/dead assay is performed on recollected cells after the procedure and cells in a control group (e.g. cells that are not injected into the microfluidic channel). The LIVE/DEAD Cell Viability Kit is applied to examine the cell viability (see description about “cell viability test” below in the “supplementary information” section for further details). For examining cell viability on recollected cells after the quantification procedure, a tube is connected to the microfluidic device outlet to collect cells, followed by mixing the prepared LIVE/DEAD Cell Viability Kit in the recollected cells. Similarly, LIVE/DEAD Cell Viability Kit is mixed in trypsinized cell suspensions to stain cells in the control group. From the cell viability staining results shown in FIG. 6A, it is noted that only few dead cells are found for both recollected cells and the control group. From the bar graph shown in FIG. 6B, it is noted that high live cell percentage is maintained after the proposed quantification procedure.

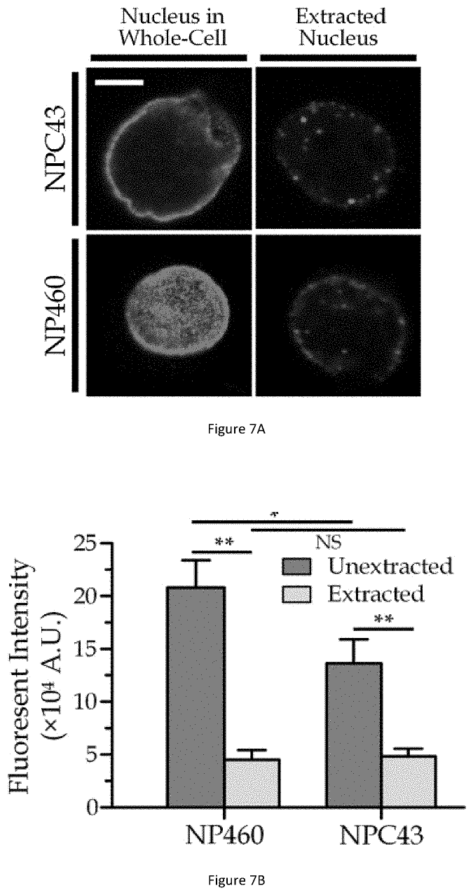

FIG. 7A illustrates immunofluorescence images of Lamin A/C expressions for nuclei in NPC43 and NP460 cells (unextracted nuclei) and the chemically extracted nuclei of NPC43 and NP460 cells. Possible causes of reduced moduli for the extracted nuclei are examined using immunofluorescence staining (see description about “Fluorescence Staining” below in the “supplementary information” for further details) for the nuclear Lamin A/C expressions, as it is known for its contribution to nuclear deformability and direct relations with nuclear elasticity. To make the staining images comparable for different cases, parameters (e.g. cell density before staining, incident laser intensity in imaging etc.) used in immunofluorescence staining and confocal microscopy imaging are controlled. The stained fluorescence intensity for unextracted and extracted nuclei are quantified based on the captured microscopic images.

FIG. 7B illustrates a bar graph showing the total fluorescence intensity of the unextracted and extracted nuclei. It is shown that the extracted nuclei have significantly lower Lamin A/C expression, suggesting that the nuclear extraction process may reduce the nuclear membrane integrity and the corresponding stiffness. The Lamin A/C expression of nuclei of NPC43 (1.36×105±SE 0.22×105 A.U) is lower than Lamin A/C expression of nuclei in NP460 (1.89×105±SE 0.26×105 A.U.), corresponding with the measured nuclear moduli. Accordingly, the non-destructive quantification procedure in the example embodiments provides more accurate results for quantifying mechanical properties of cells.

### Cell Classification

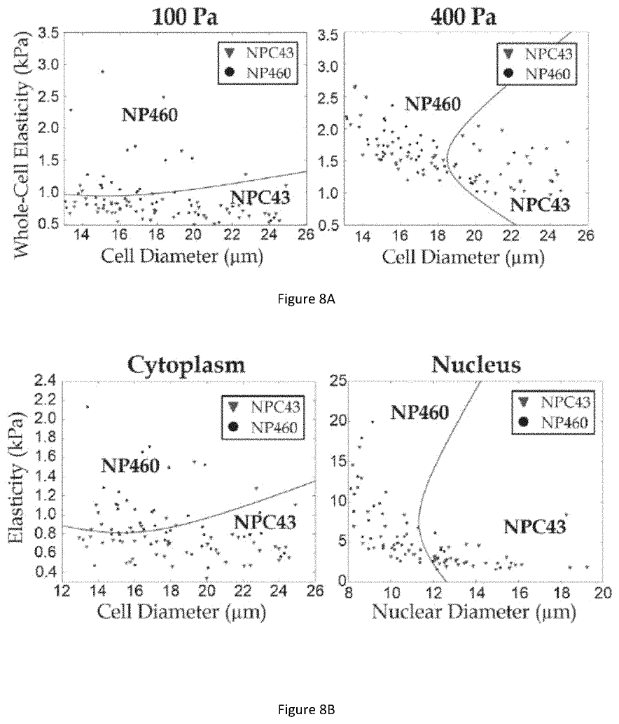

FIG. 8A illustrates scatter plot graphs for cell classification displaying values of whole cell elastic moduli against cell diameter under pressure of 100 Pa (left) and 400 Pa (right). Classification of NPC43 and NP460 cells using different measured physical properties are performed. Quadratic Discriminate Analysis (QDA) is suitable to discriminate between medical conditions that symptomatically are very similar, such as alcoholic and non-alcoholic liver disease. In particular, QDA is effective for situations where ratio of sample number to variables count is large. The cell-type classification using measured whole cell elasticity and cell diameter under a driving pressure of 100 Pa which achieves small cell deformations is shown in FIG. 8A (left). The boundary line is computed based on QDA as an optimized separating curve between properties clusters of the two cell-types. To quantify the classification performance, the accuracy (A), sensitivity values for NP460 (S-NP) and NPC43 (S-NPC), and the overall cell-type sensitivity (S) are considered. For the case of small cell deformations, the classification parameters are A=63.2%, S-NP=78.3% and S=S-NPC=58.3%. The procedure is repeated for cell quantification under 400 Pa driving pressure to achieve large cell deformations as shown in FIG. 8A (right), with the classification parameters are A=60.6%, S=S-NP=57.9% and SNPC=64.8%, which do not show any improvements compared with the classification under the pressure of 100 Pa.

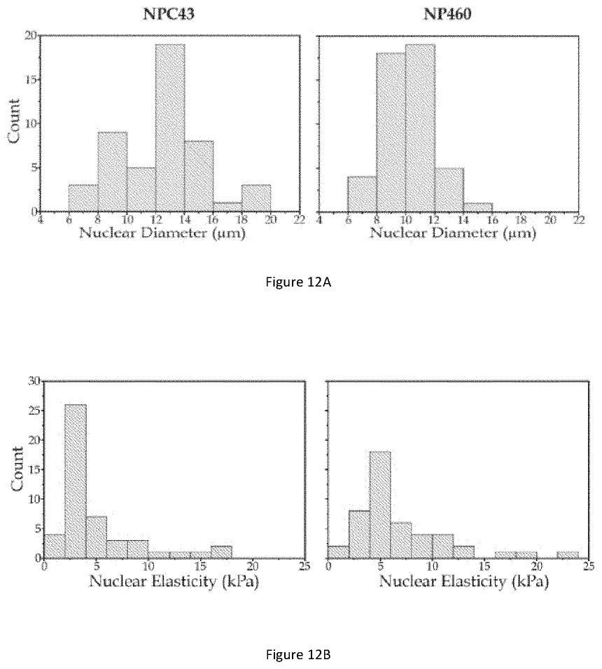

FIG. 8B illustrates scatter plot graphs for cell classifications displaying values of cytoplasmic elasticity against cell diameter (left) and nuclear elasticity versus nuclear diameter (right). QDA is performed for both cytoplasmic elasticity against cell diameter and nuclear elasticity against nuclear diameter. The classification parameters for the cytoplasmic properties are A=63.0%, S-NP=68.8% and S=S-NPC=60.0%; and the classification parameters for the nuclear properties are A=79.1%, S=S-NP=74.0% and S-NPC=86.4%. These results suggest that the classification accuracy using the elasticity values related to cell nucleus (A=79.1%) is higher than using the whole cell elasticity under both pressure levels (A<65%), implying that the nuclear elasticity values are more relevant in classifying cell properties. To further confirm nuclear elasticity differences are distinct in these two cell lines, we counted their nuclear diameters and nuclear elasticities distributions for comparison (see description below with respect to FIGS. 12A and 12B for further details), results of which suggest that nuclear elasticity is a significant factor in classifications.

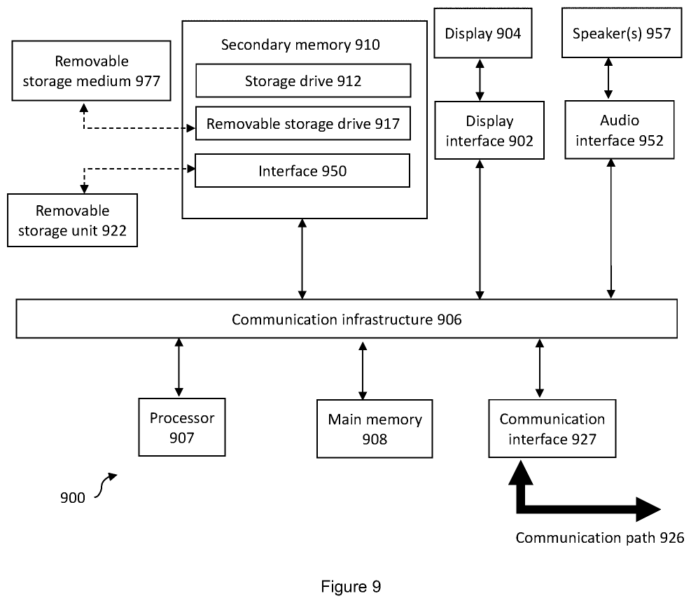

FIG. 9 depicts an exemplary computing device 900, hereinafter interchangeably referred to as a computer system 900, where one or more such computing devices 900 may be used to quantifying mechanical properties of a cell. The following description of the computing device 900 is provided by way of example only and is not intended to be limiting.

As shown in FIG. 9, the example computing device 900 includes a processor 907 for executing software routines. Although a single processor is shown for the sake of clarity, the computing device 900 may also include a multi-processor system. The processor 907 is connected to a communication infrastructure 906 for communication with other components of the computing device 900. The communication infrastructure 906 may include, for example, a communications bus, cross-bar, or network.

The software routines, or computer programs, may be stored in memory and be executable by the processor to cause the computer system 900 to: receive, from the imaging device, image data of the cell deformed within the microfluidic channel at a first deformation level and a second deformation level different from the first deformation level; determine, based on the image data, parameters associated with the deformed cell at the first deformation level and the second deformation level; calculate, using the parameters, a first elastic modulus of the cell at the first deformation level and a second elastic modulus of the cell at the second deformation level; and calculate, using the first and second elastic moduli, a nuclear modulus of the nucleus and a cytoplasmic modulus of the cytoplasm.

The computing device 900 further includes a main memory 908, such as a random access memory (RAM), and a secondary memory 910. The secondary memory 910 may include, for example, a storage drive 912, which may be a hard disk drive, a solid state drive or a hybrid drive, and/or a removable storage drive 917, which may include a magnetic tape drive, an optical disk drive, a solid state storage drive (such as a USB flash drive, a flash memory device, a solid state drive or a memory card), or the like. The removable storage drive 917 reads from and/or writes to a removable storage medium 977 in a well-known manner. The removable storage medium 977 may include magnetic tape, optical disk, non-volatile memory storage medium, or the like, which is read by and written to by removable storage drive 917. As will be appreciated by persons skilled in the relevant art(s), the removable storage medium 977 includes a computer readable storage medium having stored therein computer executable program code instructions and/or data.

In an alternative implementation, the secondary memory 910 may additionally or alternatively include other similar means for allowing computer programs or other instructions to be loaded into the computing device 900. Such means can include, for example, a removable storage unit 922 and an interface 950. Examples of a removable storage unit 922 and interface 950 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 922 and interfaces 950 which allow software and data to be transferred from the removable storage unit 922 to the computer system 900.

The computing device 900 also includes at least one communication interface 927. The communication interface 927 allows software and data to be transferred between computing device 900 and external devices via a communication path 926. In various embodiments of the inventions, the communication interface 927 permits data to be transferred between the computing device 900 and a data communication network, such as a public data or private data communication network. The communication interface 927 may be used to exchange data between different computing devices 900 which such computing devices 900 form part an interconnected computer network. Examples of a communication interface 927 can include a modem, a network interface (such as an Ethernet card), a communication port (such as a serial, parallel, printer, GPIB, IEEE 1394, RJ45, USB), an antenna with associated circuitry and the like. The communication interface 927 may be wired or may be wireless. Software and data transferred via the communication interface 927 are in the form of signals which can be electronic, electromagnetic, optical or other signals capable of being received by communication interface 927. These signals are provided to the communication interface via the communication path 926.

As shown in FIG. 9, the computing device 900 further includes a display interface 902 which performs operations for rendering images to an associated display 904 and an audio interface 952 for performing operations for playing audio content via associated speaker(s) 957.

As used herein, the term “computer program product” may refer, in part, to removable storage medium 977, removable storage unit 922, a hard disk installed in storage drive 912, or a carrier wave carrying software over communication path 926 (wireless link or cable) to communication interface 927. Computer readable storage media refers to any non-transitory, non-volatile tangible storage medium that provides recorded instructions and/or data to the computing device 900 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 900. Examples of transitory or non-tangible computer readable transmission media that may also participate in the provision of software, application programs, instructions and/or data to the computing device 900 include radio or infra-red transmission channels as well as a network connection to another computer or networked device, and the Internet or Intranets including e-mail transmissions and information recorded on Web sites and the like.

The computer program product may store instructions executable by the processor to cause the computer system 900 to: receive, from the imaging device, image data of the cell deformed within the microfluidic channel at a first deformation level and a second deformation level different from the first deformation level; determine, based on the image data, parameters associated with the deformed cell at the first deformation level and the second deformation level; calculate, using the parameters, a first elastic modulus of the cell at the first deformation level and a second elastic modulus of the cell at the second deformation level; and calculate, using the first and second elastic moduli, a nuclear modulus of the nucleus and a cytoplasmic modulus of the cytoplasm.

The computer programs (also called computer program code) are stored in main memory 908 and/or secondary memory 910. Computer programs can also be received via the communication interface 927. Such computer programs, when executed, enable the computing device 900 to perform one or more features of embodiments discussed herein. In various embodiments, the computer programs, when executed, enable the processor 907 to perform features of the above-described embodiments. Accordingly, such computer programs represent controllers of the computer system 900.

Software may be stored in a computer program product and loaded into the computing device 900 using the removable storage drive 917, the storage drive 912, or the interface 950. The computer program product may be a non-transitory computer readable medium. Alternatively, the computer program product may be downloaded to the computer system 900 over the communications path 926. The software, when executed by the processor 907, causes the computing device 900 to perform functions of embodiments described herein.

It is to be understood that the embodiment of FIG. 9 is presented merely by way of example. Therefore, in some embodiments one or more features of the computing device 900 may be omitted. Also, in some embodiments, one or more features of the computing device 900 may be combined together. Additionally, in some embodiments, one or more features of the computing device 900 may be split into one or more component parts.

When the computing device 900 is configured to quantify mechanical properties of a cell, the computing system 900 will have a non-transitory computer readable medium having stored thereon an application which when executed causes the computing system 900 to perform steps comprising: receive, from the imaging device, image data of the cell deformed within the microfluidic channel at a first deformation level and a second deformation level different from the first deformation level; determine, based on the image data, parameters associated with the deformed cell at the first deformation level and the second deformation level; calculate, using the parameters, a first elastic modulus of the cell at the first deformation level and a second elastic modulus of the cell at the second deformation level; and calculate, using the first and second elastic moduli, a nuclear modulus of the nucleus and a cytoplasmic modulus of the cytoplasm.

### Supplementary Information

### 3D Nuclear Shapes of NP460 and NPC43 Cells

FIG. 10A illustrates a 3D view of a Hoechst 33342 stained NPC43 cell and the cross-sectional views across x-, y- and z-planes. FIG. 10B illustrates a 3D view of a Hoechst 33342 stained NPC460 cell and the cross-sectional views across x-, y- and z-planes. Laser confocal microscopy is used to obtain 3D images of Hoechst 33342 stained nuclei to further verify whether nuclei of NP460 and NPC43 cells are in substantially spherical shapes. Briefly, a fluorescent nucleus is scanned from the top to bottom across multiple planes (typically ˜100 planes scanned) on a laser confocal microscope and 3D view of stained nucleus is generated. As shown in FIG. 10A and FIG. 10B, nuclei of both NPC43 and NP460 cells are in substantially spherical shapes. Accordingly, performing the measurements with the assumption that of NPC43 and NP460 cells and nuclei are soft spheres result in more accurate outcome and less errors.

### Effective Pressure Difference on Single Confining Microfluidic Channels

FIG. 11A illustrates diagram of the flow sections in the whole microfluidic device. To study the effective pressure difference driven on a single confining microfluidic channel, the total microfluidic device is divided into several flow sections. As illustrated in FIG. 11A, the whole device can be considered as consisting of a main flow section (Rm), four bypass channels (R1, R2, R3, R4), and a downstream outflow channel (Rout).

FIG. 11B illustrates a circuit model of flow resistances distributions for flow sections. The effective pressure differences on each flow section can be calculated by considering circuit model of flow resistances. As shown in FIG. 11B, the flow resistance of the whole microfluidic device can be considered as a main flow section connected in parallel with four bypass channels and then connected in series with an outflow channel. The flow resistances can be calculated by:

$$R = \frac{\overline{p}}{S} \qquad ( 15 )$$

where

R is the flow resistance of flow section

p̅ is the average pressure in flow section

S is integrated flow rate in flow section

After implementing COMSOL Multiphysics 5.2a (Burlington, Mass.) to calculate average pressures and flow rates for every flow section, flow resistances of each flow section can be obtained by using Equation (15) as shown in the table below:

TABLE S1
Calculated flow resistances of every flow
section in the microfluidic device.

| | Rₘ | R₁ | R₂ | R₃ | R₄ | Rₒᵤₜ |
|---|---|---|---|---|---|---|
| Flow | 5.57 × | 6.89 × | 6.87 × | 6.09 × | 6.11 × | 1.29 × |
| Resistance | 10⁹ | 10¹⁰ | 10¹⁰ | 10¹⁰ | 10¹⁰ | 10⁷ |
| (Pa · s/m³) | | | | | | |

The total flow resistance of the parallel connected group R* can be calculated by:

$$\frac{1}{{R}^{*}} = \frac{1}{{R}_{m}} + \frac{1}{{R}_{1}} + \frac{1}{{R}_{2}} + \frac{1}{{R}_{3}} + \frac{1}{{R}_{4}} \qquad ( 16 )$$

By substituting values in Table S1 in Equation (16), R*=4.14×10⁹ Pa·s/m3. After considering the pressure distributions according to the flow resistances, the effective pressure difference of the main flow section is

$${P}_{eff} = {P}_{drive} \cdot \frac{{R}^{*}}{{R}^{*} + {R}_{out}} = 99.69 \% \cdot {P}_{drive}$$

where

P_{eff} is the effective pressure difference of the main flow section

P_{drive} is the driving pressure applied on the whole microfluidic device

Since every confining microfluidic channel is connected in parallel with the main flow section, the pressure difference between inlets and outlets is similar to the flow section pressure. Therefore, the pressure applied to the cells are similar to the pressure difference between inlets and outlets of microfluidic channels.

### Nuclear Size and Elasticity Distributions of Measured NP460 and NPC43 Cells

FIG. 12A illustrates bar graphs showing nuclear diameter distributions of NP460 and NPC43 cells. FIG. 12B illustrates bar graphs showing nuclear elasticity distributions of NP460 and NPC43 cells.

To discover the feasibility of classifying NPC43 cells from NP460 cells using nuclear diameters and elasticities, the nuclear diameter distributions and nuclear elastic moduli distributions are firstly counted separately. As shown in FIGS. 12A and 12B, it is obvious that significant distribution difference can be found between two cell lines in both nuclear diameter and nuclear elasticity. For nuclear diameter distributions, NP460 cells centralize in the group ranging from 8 μm to 12 μm while NPC43 cells tend to distribute in group ranging from 12 μm to 14 μm. If nuclear diameter value of 12 μm is taken as the nuclear size separating boundary, there will be 64.6% NPC43 cells in the ‘larger’ domain and 87.2% NP460 cells in the ‘smaller’ domain. When considering the nuclear elasticity, majority of measured NPC43 cells have nuclear elasticities ranging from 2 kPa to 4 kPa, while a large number of measured NP460 cells have nuclear elasticity ranging from 4 kPa to 6 kPa. If nuclear elastic modulus value of 4 kPa is taken as the nuclear stiffness separating boundary, there will be 62.5% NPC43 cells in ‘softer’ domain and 78.7% NP460 cells in ‘stiffer’ domain.

### Device Fabrication

The microfluidic device is fabricated mainly based on soft photolithography, with a two-step replica molding of polydimethylsiloxane (PDMS) for transferring high aspect-ratio microstructures of a silicon mold to a PDMS substrate. The silicon mold master is manufactured by firstly patterning positive photoresist (AZ5214, AZ Electronic Materials, Branchburg, NI) to a silicon wafer, followed by deep reactive ion etching (DRIE) and stripping the photoresist. Next, the first-stage standard replica molding process is applied using the silicon mold master to obtain a PDMS substrate with the reversed microstructures, acting as a negative mold. A molecular layer of trichloro (1H, 1H, 2H, 2H-perfluoro-octyl) silane (Sigma-Aldrich) is applied on microstructures of the PDMS mold. The silanized PDMS mold is immersed in deionized water and oven for 1 hour, in order to further remove any excessive silane coating. Another round of the standard replica molding of PDMS is then applied on the silanized PDMS mold. Holes at punched at the inlets and outlets of the PDMS substrate. The micropatterned side of the newly molded PDMS substrate is bonded on a glass slide using oxygen plasma treatment (Plasma Prep II, SPI Supplies) such that the microfluidic device is formed. Afterward, cell-repelling pluronics F-127 (Sigma-Aldrich) molecules is applied along the microfluidic channels to eliminate cell attachment on the channel walls.

### Cell Culture

An immortalised human nasopharyngeal epithelial cell line (NP460) and a nasopharyngeal cancer cell line (NPC43) are expanded in culture flasks. NP460 cells are cultured in a cell culture media comprising 50% complete Eplife medium (Thermo Fisher Scientific), 50% complete Defined Keratinocyte-SFM (Thermo Fisher Scientific), 100 units/ml penicillin, and 100 μg/ml streptomycin. NPC43 cells are cultured in RPMI-1640 (Sigma) supplemented with 10% fetal bovine serum, 4 uM Y27632 dihydrochloride (Alexis), 100 unit/ml penicillin, and 100 μg/ml streptomycin.

Both the cell types are cultivated in an incubator at 37° C., saturated humidity and 5% CO₂ in air. Once the cell population reached ˜80% confluence, cell passaging is performed by applying 0.25 trypsin-EDTA, centrifuging, and resuspending the cells back in fresh media for the subsequent incubation.

### Nucleus Extraction

The cells are trypsinised using 0.25 trypsin-EDTA and resuspended in cell culture media. The cells are then transferred into a pre-chilled syringe tube, centrifuged, and the culture media is removed by aspiration. Hypotonic buffer solution (20 mM Tris-HCl, 10 mM NaCl, 3 mM MgCl₂) and pipetting are applied, followed by placing the syringe tube in ice for 20 min. Next, 10% NP40 detergent (ThermoFisher Scientific) is added to the cell suspension and mixed at 2500 rpm for 15 seconds to chemically extract the cell nuclei. The sample is further processed μm through cell strainers (STEMCELL Technologies Inc.) with a 37 μm pore size to remove larger cell debris. After centrifuging and removing the supernatant, which mostly contained the cytoplasmic fraction, the remaining pellet is resuspended to obtain the nuclei.

### Fluorescence Staining

Hoechst 33342 (Thermo Fisher Scientific) with a concentration of 0.1 μg/ml in FIBS or culture medium is applied for 5 min to stain DNAs in either whole cells and extracted nuclei. Immunofluorescence staining is applied on both intact cells and extracted nuclei. For staining nucleoskeleton of the intact cells, they are first detached by 0.25% trypsin-EDTA in phosphate-buffered saline (PBS, Sigma-Aldrich, St. Louis, Mo.). Each population of ˜10⁵ cells is transferred to a syringe tube for the following steps. The cell sample is centrifuged, followed by aspiration. The cells are then fixed with 4% Paraformaldehyde (PFA; Sigma-Aldrich, St. Louis, Mo.) for 15 minutes. Next, cells are washed with PBS. Triton X-100 is added to PBS for a volumetric ratio of 0.3% for 20 minutes to permeabilize the cells. The solution is blocked with 3% Bovine serum albumin (BSA) for 1 hour to prevent the non-specific bindings in the following steps. The cells are then incubated in a primary antibody (Lamin A/C monoclonal antibody; Thermo Fisher Scientific) at a dilution of 1:100 in 3% BSA for 1 hour, followed by washing the cells with the final cell culture media containing BSA. Cells are then incubated in a secondary antibody (Alexa-555; Life Technologies, Carlsbad, Calif.) at a dilution of 1:1500 in 3% BSA in the dark for 1 hour. After washing the cells twice, they are resuspended for a cell concentration of ˜10⁵ cells/ml. The staining procedures for nucleoskeleton in the isolated nuclei are the same as for the intact cells.

### Cell Viability Test

The cell viability test of recollected cells and cells in the group is performed by using the LIVE/DEAD Cell Viability Kit (Life Technologies). The prepared staining reagents are added into cell suspensions for 20 min to stain live/dead cells with different fluorescent signals.

### Image Capture and Processing

Bright-field microscopic images are captured under an inverted microscope (TE300, Nikon) equipped with an sCMOS microscope camera (Zyla 4.2, Andor). The captured microscopic images are processed using ImageJ (NIH) for obtaining the key parameters mentioned in this work such as the diameter of cells and nuclei, as well as the penetration length in microfluidic channels. The elastic moduli are computed by customized scripts of MATLAB 2017a (MathWorks, MA, USA) written by the inventors. On the other hand, the immunofluorescence images are captured by a confocal laser scanning microscope (ZEISS LSM 880). Fluorescence intensity of captured confocal images is measured using ImageJ.

### Simulation

Simulation of the laminar flow along a cell/nucleus-containing microfluidic channel is conducted with COMSOL 5.2a (Burlington, Mass.). The pressure distribution around a cell/nucleus with a size ranging from 6 μm to 20 μm at a defined position along the microfluidic channel is analyzed for the case under 1 kPa driving pressure. Briefly, the laminar flow physics is applied to compute the pressure distributions for situations that a cell/nucleus captured in different positions of single confining microfluidic channels. Geometries of a cell/nucleus are directly built at different positions in COMSOL 5.2a. The driving fluid material is selected as water from the material library and the captured cell/nucleus is selected as a blank matter with related properties (density=1,110 kg/m³, dynamic viscosity=0.033 Pa·s 40). Fine mesh is selected as the fluid dynamic type. Governing equations in laminar flow simulation are:

ρ(u·∀)u=∀·[−p+μ(∀u+(∀u)^{T})]+F

ρ∀·(u)=0

where

ρ is the density of fluid

u is the fluid velocity

μ is the fluid dynamic viscosity

p is the fluid pressure

F is the force contributed by the interfacial forces at adjacent interface

The pressure distributions are computed for each case based on channel inlet pressure of 1 kPa, outlet pressure of 0 kPa and the cell-fluid interface is considered as the interior wall. Next, the effective drag force on the captured cell/nucleus can be calculated by integrating its surface stresses around, which is obtained using ‘Surface Integration’ in COMSOL 5.2a to integrate the stresses in the flow direction on the captured cell/nucleus surface.

### Classification Regime

Classifications of cells are based on the Quadratic Discriminate Analysis (QDA) regime. The classification of cell lines is calculated according to two cell/nucleus property variables in QDA. Customized scripts are programmed to classify scatters of two cell variables and elasticity using MATLAB R2017a (MathWorks) to realize QDA.

Embodiments of the present invention provide a non-destructive procedure to quantify mechanical properties of cells using microfluidic devices. The quantification procedure can be used to perform measurements on live whole cell and the cells can be easily recollected thereafter by increasing the driving pressure as the procedure does not destruct the cells structures. This makes further analysis of the cells feasible. Further, the results obtained from the proposed quantification procedure are not sensitive to the measurement positions of the cells since the nuclear mechanical properties are calculated using hyperelastic Tatara's theory by measuring whole cell deformations. Thus, accurate mechanical properties can be obtained using the quantification procedure as disclosed herein. The cost for the microfluidic device is also inexpensive as the microfluidic device is made using polydimethylsiloxane and glass slide.

It will be appreciated by a person skilled in the art that numerous variations and/or modifications may be made to the present invention as shown in the specific embodiments without departing from the scope of the invention as broadly described. The present embodiments are, therefore, to be considered in all respects to be illustrative and not restrictive.

1. A system for quantifying mechanical properties of a cell containing a nucleus and cytoplasm, the system comprising:
a microfluidic channel comprising an inlet configured to receive the cell and an outlet in fluid communication with the inlet, wherein the microfluidic channel comprises a varying width configured to deform the cell to multiple deformation levels;
an imaging device configured to obtain image data of the cell received by the microfluidic channel; and
a processor in communication with the imaging device, wherein the processor is configured to:
receive, from the imaging device, image data of the cell deformed within the microfluidic channel at a first deformation level and a second deformation level different from the first deformation level;
determine, based on the image data, one or more parameters associated with the deformed cell at the first deformation level and the second deformation level;
calculate, using the one or more parameters, a first elastic modulus of the cell at the first deformation level and a second elastic modulus of the cell at the second deformation level; and
calculate, using the first and second elastic moduli, a nuclear modulus of the nucleus and a cytoplasmic modulus of the cytoplasm.

2. The system as claimed in claim 1, wherein the parameters are selected from a group consisting of: a penetration length of the cell from the inlet of the microfluidic channel, a length of the cell measured along a length of the microfluidic channel, a width of the cell measured along a width of the microfluidic channel and a diameter of the cell in an undeformed state.

3. The system as claimed in claim 1, wherein the first deformation level comprises a deformation of the cytoplasm and the nucleus is undeformed, and wherein the second deformation level comprises a deformation of both the cytoplasm and the nucleus.

4. The system as claimed in claim 1, wherein the microfluidic channel comprises a width that tapers from the inlet towards the outlet.

5. The system as claimed in claim 1, wherein the processor is configured to calculate the first and second elastic moduli using the parameters in a hyperelastic Tatara model.

6. The system as claimed in claim 1, wherein the system further comprises a fluid pump configured to:
apply a first pressure through the inlet to move the cell along the microfluidic channel until the cell is deformed to the first deformation level; and
apply a second pressure through the inlet to move the cell along the microfluidic channel until the cell is deformed to the second deformation level, wherein the second pressure is higher than the first pressure.

7. The system as claimed in claim 1, wherein the processor is further configured to classify the cell using a quadratic discriminant analysis based on the nuclear modulus of the nucleus.

8. The system as claimed in claim 1, wherein inlet comprises a width of 10 μm-50 μm and the outlet comprises a width of 1 μm-10 μm.

9. The system as claimed in claim 1, wherein the cell comprises one selected from a group consisting of an adherent cell, a suspension cell, a non-adherent cell and a dissociated adherent cell.

10. A method for quantifying mechanical properties of a cell containing a nucleus and cytoplasm, the method comprising:
obtaining image data of the cell deformed within a microfluidic channel at a first deformation level and a second deformation level different from the first deformation level, the microfluidic channel comprising an inlet configured to receive the cell and an outlet in fluid communication with the inlet, wherein the microfluidic channel comprises a varying width configured to deform the cell to multiple deformation levels;
determining, based on the image data, one or more parameters associated with the deformed cell at the first deformation level and the second deformation level;
calculating, using the one or more parameters, a first elastic modulus of the cell at the first deformation level and a second elastic modulus of the cell at the second deformation level; and
calculating, using the first and second elastic moduli, a nuclear modulus of the nucleus and a cytoplasmic modulus of the cytoplasm.

11. The method as claimed in claim 10, wherein the parameters are selected from a group consisting of: a penetration length of the cell from the inlet of the microfluidic channel, a length of the cell measured along a length of the microfluidic channel, a width of the cell measured along a width of the microfluidic channel and a diameter of the cell in an undeformed state.

12. The method as claimed in claim 10, wherein the first deformation level comprises a deformation of the cytoplasm and the nucleus is undeformed, and wherein the second deformation level comprises a deformation of both the cytoplasm and the nucleus.

13. The method as claimed in claim 10, wherein calculating the first and second elastic moduli comprises using the parameters in a hyperelastic Tatara model.

14. The method as claimed in claim 10, wherein the microfluidic channel comprises a width that tapers from the inlet towards the outlet.

15. The method as claimed in claim 10, obtaining image data of the cell comprises:
applying a first pressure, using a fluid pump, through the inlet to move the cell along the microfluidic channel until the cell is deformed to the first deformation level;
capturing a first image of the cell at the first deformation level;
applying a second pressure, using the fluid pump, through the inlet to move the cell along the microfluidic channel until the cell is deformed to the second deformation level, wherein the second pressure is higher than the first pressure; and
capturing a second image of the cell at the second deformation level.

16. The method as claimed in claim 10, further comprises classifying the cell using a quadratic discriminant analysis based on the nuclear modulus of the nucleus.

17. The method as claimed in claim 10, wherein the inlet comprises a width of 10 μm-50 μm and the outlet comprises a width of 1 μm-10 μm.

18. The method as claimed in claim 10, wherein the cell comprises one selected from a group consisting of an adherent cell, a suspension cell, a non-adherent cell and a dissociated adherent cell.
